(19) United States
(12) Patent Application Publication
(10) Pub. No.: US 2011/0112700 A1
(43) Pub. Date: May 12, 2011

(54) ELECTRIC POWER SUPPLY DEVICE, ELECTRIC POWER RECEIVING DEVICE, ELECTRIC POWER SUPPLY SYSTEM, AND FAILURE RECOVERY METHOD

(75) Inventor: Shigeru TAJIMA, Kanagawa (JP)

(73) Assignee: SONY CORPORATION, Tokyo (JP)

(21) Appl. No.: 12/891,010

(22) Filed: Sep. 27, 2010

(30) Foreign Application Priority Data
Nov. 6, 2009 (JP) 2009-255233

(51) Int. Cl. G06F 1/28

(52) U.S. Cl. 700/293; 700/286

(57) ABSTRACT

An electric power supply device is provided that includes an electric power supply portion, an information communication portion, a control portion, and an impedance measurement portion. The electric power supply portion supplies, to another device with which an agreement has been established to supply electric power, the electric power that the agreement specifies, by supplying the electric power to a bus line during predetermined electric power supply intervals that recur cyclically. The information communication portion wirelessly transmits and receives, to and from the other device to which the electric power supply portion supplies the electric power, information signals that express information. The control portion controls the electric power that the electric power supply portion supplies and the information signals that the information communication portion transmits. The impedance measurement portion measures the impedance of the bus line on a specified cycle.

### BACKGROUND OF THE INVENTION

1. Field of the Invention

The present invention relates to an electric power supply device, an electric power receiving device, an electric power supply system, and a failure recovery method.

2. Description of the Related Art

For many electronic devices such as personal computers and game units, AC adapters are used that input alternating current (AC) electric power from a commercial electric power supply and output electric power that is matched to the devices, in order to operate the devices and charge their batteries. The electronic devices ordinarily operate on direct current (DC), but the voltages and currents vary according to the device. The standards for the AC adapters that output the electric power that is matched to the devices are therefore different for each device, and even AC adapters that have the same sort of shape are not interchangeable, which has created a problem in that the number of AC adapters has increased as the types of electronic devices have increased.

To address this problem, an electric power supply bus system has been proposed in which an electric power supply block that supplies electric power to devices such as a battery, an AC adapter, and the like, and an electric power consumption block to which the electric power from the electric power supply block is supplied are connected to single, common direct current bus line (refer, for example, to Japanese Patent Application Publication No. JP-A-2001-306191 and Japanese Patent Application Publication No. JP-A-2008-123051). In the electric power supply bus system, direct current electricity flows through the bus line. Furthermore, in the electric power supply bus system, each of the blocks describes itself as an object, and the objects for the respective blocks reciprocally transmit and receive information (status data) through the bus line. The object for each of the blocks also creates information (status data) based on a request from the object for the other block and transmits the created information as reply data. The object for the block that receives the reply data can then control the supply and the consumption of the electric power based on the content of the received reply data.

### SUMMARY OF THE INVENTION

In the electric power supply bus system that is described above, it is conceivable that at least one of an electric power server that supplies the electric power and a client that consumes the electric power may malfunction, as well as that the system as a whole may malfunction. However, a problem exists in that no method has been described for recovery in a case where the electric power supply bus system malfunctions.

Accordingly, the present invention, in light of the problem that is described above, provides an electric power supply device, an electric power receiving device, an electric power supply system, and a failure recovery method that are new and improved and that are capable of recovering from a malfunction when, in the electric power supply bus system that is described above, a malfunction occurs in at least one of the electric power server that supplies the electric power, the client that consumes the electric power, and the system as a whole.

In order to address the issues that are described above, according to an aspect of the present invention, there is provided an electric power supply device that includes an electric power supply portion, an information communication portion, a control portion, and an impedance measurement portion. The electric power supply portion supplies, to another device with which an agreement has been established to supply electric power, the electric power that the agreement specifies, by supplying the electric power to a bus line during predetermined electric power supply intervals that recur cyclically. The information communication portion wirelessly transmits and receives, to and from the other device to which the electric power supply portion supplies the electric power, information signals that express information. The control portion controls the electric power that the electric power supply portion supplies and the information signals that the information communication portion transmits. The impedance measurement portion measures the impedance of the bus line on a specified cycle.

In a case where the impedance of the bus line that is measured by the impedance measurement portion is outside a predetermined range of normal values, the control portion may also issue a command to start self-diagnostic processing to the other device that is receiving the electric power supply from the electric power supply portion.

In a case where the impedance of the bus line that is measured by the impedance measurement portion is outside a predetermined range of normal values, the control portion may also issue a command to itself to start self-diagnostic processing.

In a case where the self-diagnostic processing determines that a malfunction has occurred in the control portion, the control portion may also stop the electric power supply from the electric power supply portion.

In order to address the issues that are described above, according to another aspect of the present invention, there is provided an electric power receiving portion that includes an electric power receiving portion, an information communication portion, a control portion, and an impedance measurement portion. The electric power receiving portion receives, from another device with which an agreement has been established to supply electric power, the electric power that the agreement specifies, from a bus line during predetermined electric power supply intervals that recur cyclically. The information communication portion wirelessly transmits and receives, to and from the other device from which the electric power receiving portion receives the electric power, information signals that express information. The control portion controls the information signals that the information communication portion transmits. The impedance measurement portion measures the impedance of the bus line on a specified cycle.

In a case where the impedance of the bus line that is measured by the impedance measurement portion is outside a predetermined range of normal values, the control portion may also issue a command to the information communication portion to transmit a notification to the effect that the impedance is abnormal to the other device that is supplying the electric power.

In a case where the impedance of the bus line that is measured by the impedance measurement portion is outside a predetermined range of normal values, the control portion may also issue a command to itself to start self-diagnostic processing.

In a case where the self-diagnostic processing determines that a malfunction has occurred in the control portion, the control portion may also issue a command to the information communication portion to transmit a notification to the effect that the receiving of the electric power will stop.

In order to address the issues that are described above, according to another aspect of the present invention, there is provided an electric power supply system that includes an electric power supply server that outputs electric power to a bus line at a specified timing and a client that receives, through the bus line, the electric power that the electric power supply server outputs. The electric power supply server includes an electric power supply portion, an information communication portion, a control portion, and an impedance measurement portion. The electric power supply portion supplies, to another device with which an agreement has been established to supply electric power, the electric power that the agreement specifies, during predetermined electric power supply intervals that recur cyclically. The information communication portion wirelessly transmits and receives, to and from the other device to which the electric power supply portion supplies the electric power, information signals that express information. The control portion controls the electric power that the electric power supply portion supplies and the information signals that the information communication portion transmits. The impedance measurement portion measures the impedance of the bus line on a specified cycle. The client includes an electric power receiving portion, an information communication portion, a control portion, and an impedance measurement portion. The electric power receiving portion receives, from another device with which an agreement has been established to supply electric power, the electric power that the agreement specifies, during predetermined electric power supply intervals that recur cyclically. The information communication portion wirelessly transmits and receives, to and from the other device from which the electric power receiving portion receives the electric power, information signals that express information. The control portion controls the information signals that the information communication portion transmits. The impedance measurement portion measures the impedance of the bus line on a specified cycle.

In order to address the issues that are described above, according to another aspect of the present invention, there is provided a failure recovery method that includes a step of supplying, to another device with which an agreement has been established to supply electric power, the electric power that the agreement specifies, by supplying the electric power to a bus line during predetermined electric power supply intervals that recur cyclically. The failure recovery method also includes a step of transmitting and receiving wirelessly, to and from the other device to which the electric power is supplied, information signals that express information. The failure recovery method also includes a step of controlling the electric power that is supplied and the information signals that are transmitted. The failure recovery method also includes a step of measuring the impedance of the bus line on a specified cycle.

According to the present invention, it is possible to provide an electric power supply device, an electric power receiving device, an electric power supply system, and a failure recovery method that are new and improved and that are capable of recovering from a malfunction when, in the electric power supply bus system that is described above, a malfunction occurs in at least one of the electric power server that supplies the electric power, the client that consumes the electric power, and the system as a whole.

### BRIEF DESCRIPTION OF THE DRAWINGS

FIG. 1 is an explanatory figure that shows a configuration of an electric power supply system 1 according to an embodiment of the present invention;

FIG. 2 is an explanatory figure that explains electric power supply processing by the electric power supply system 1 according to the embodiment of the present invention;

FIG. 3 is a flowchart that shows self-diagnostic processing;

FIG. 4 is an explanatory figure that shows a configuration of an electric power supply server 100 according to the embodiment of the present invention;

FIG. 5 is an explanatory figure that shows a configuration of a client 200 according to the embodiment of the present invention; and

FIG. 6 is an explanatory figure that shows a configuration of a monitoring device 300 that is connected to the electric power supply system 1 according to the embodiment of the present invention.

### DETAILED DESCRIPTION OF EMBODIMENT

Hereinafter, a preferred embodiment of the present invention will be described in detail with reference to the appended drawings. Note that, in this specification and the appended drawings, structural elements that have substantially the same function and structure are denoted with the same reference numerals, and repeated explanation of these structural elements is omitted.

Note that the explanation will be in the order shown below.
1. Embodiment of the present invention
1-1. Configuration of electric power supply system
1-2. Electric power supply processing by electric power supply system
1-3. Method for recovering when malfunction occurs
1-4. Electric power supply server configuration example
1-5. Client configuration example
1-6. Monitoring device configuration example
2. Conclusion

### 1. Embodiment of the Present Invention

### 1-1. Configuration of Electric Power Supply System

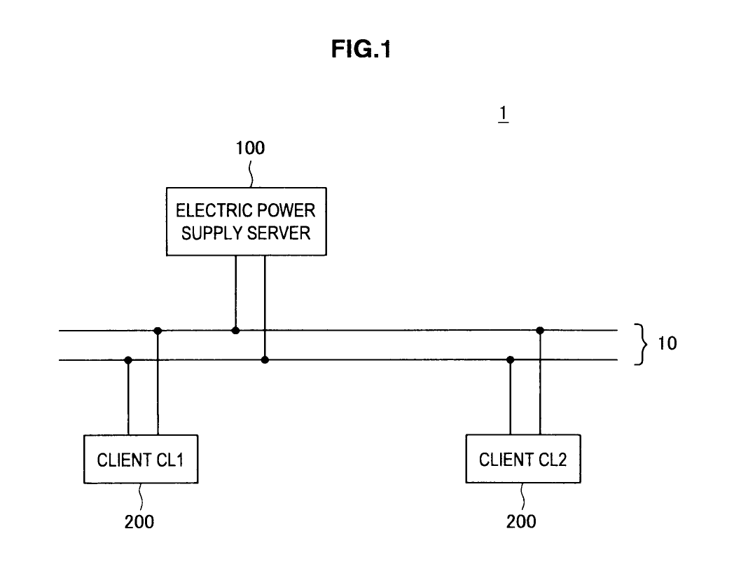

First, a configuration of an electric power supply system 1 according to an embodiment of the present invention will be explained. FIG. 1 is an explanatory figure that shows the configuration of the electric power supply system 1 according to the embodiment of the present invention. Hereinafter, the configuration of the electric power supply system 1 according to the embodiment of the present invention will be explained using FIG. 1.

As shown in FIG. 1, the electric power supply system 1 according to the embodiment of the present invention is configured such that it includes an electric power supply server 100 and clients 200. The electric power supply server 100 and the clients 200 are connected through a bus line 10.

The electric power supply server 100 supplies direct current electric power to the clients 200. The electric power supply server 100 also transmits and receives information signals to and from the clients 200. In the present embodiment, the supplying of the direct current electric power and the transmitting and the receiving of the information signals between the electric power supply server 100 and the clients 200 both use the bus line 10.

The electric power supply server 100 is configured such that it includes a communication modem for the transmitting and the receiving of the information signals, a microprocessor for controlling the supplying of the electric power, a switch that controls the output of the direct current electric power, and the like.

The clients 200 receive the supply of the direct current electric power from the electric power supply server 100. The clients 200 also transmit and receive the information signals to and from the electric power supply server 100. Two of the clients 200 are shown in FIG. 1. Hereinafter, in order to simplify the explanation, the two clients 200 are distinguished as CL1 and CL2, respectively.

Each of the clients 200 is configured such that it includes a communication modem for the transmitting and the receiving of the information signals, a microprocessor for controlling the supplying of the electric power, a switch that controls the output of the direct current electric power, and the like.

Note that in the electric power supply system 1 that is shown in FIG. 1, the one electric power supply server 100 and the two clients 200 are shown, but in the present embodiment, the number of the electric power supply servers and the number of the clients are obviously not limited to this example.

The method for supplying the electric power in the electric power supply system 1 that is shown in FIG. 1 has been described in Japanese Patent Application Publication No. JP-A-2008-123051, so a detailed explanation will be omitted here, but electric power supply processing by the electric power supply system 1 according to the embodiment of the present invention will hereinafter be explained briefly.

### 1-2. Electric Power Supply Processing by Electric Power Supply system

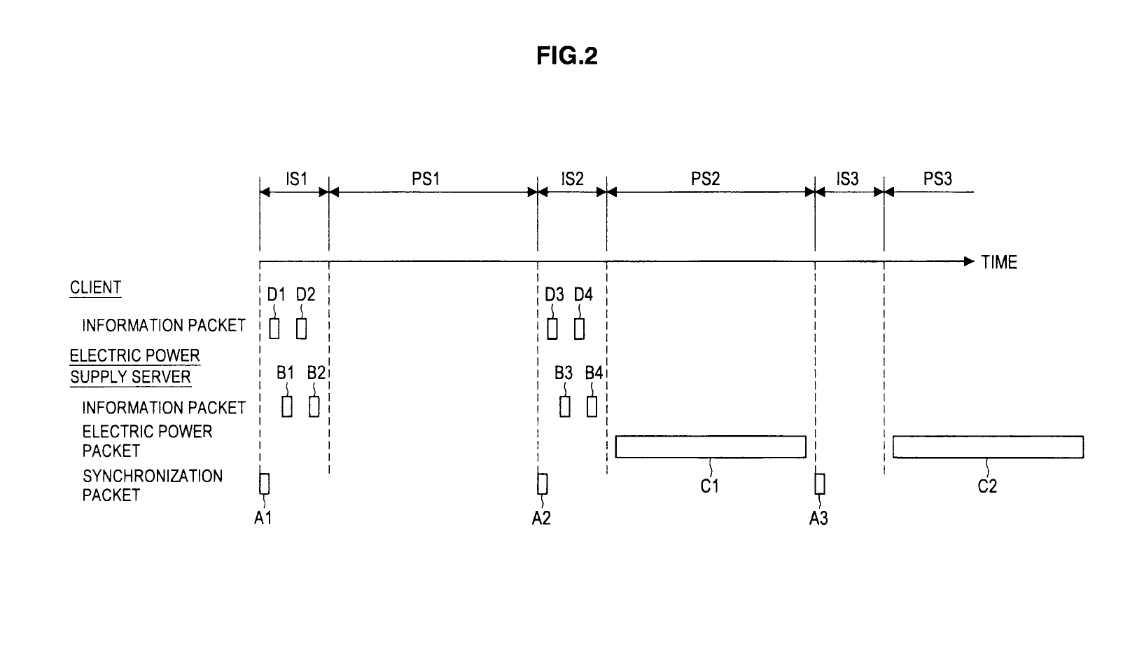

FIG. 2 is an explanatory figure that explains the electric power supply processing by the electric power supply system 1 according to the embodiment of the present invention. Hereinafter, the electric power supply processing by the electric power supply system 1 according to the embodiment of the present invention will be explained using FIG. 2.

As shown in FIG. 2, the electric power supply server 100 outputs synchronization packets A1, A2, A3, and the like to the bus line 10 at regular intervals. Furthermore, in order to supply the electric power to the clients CL1, CL2, the electric power supply server 100 outputs information packets B1, B2, B3, and the like that are the information signals that are transmitted to the clients CL1, CL2, as well as electric power packets C1, C2, C3, and the like. For their part, the clients CL1, CL2, in order to receive the supply of the electric power from the electric power supply server 100, output information packets D1, D2, D3, and the like that are the information signals that are transmitted to the electric power supply server 100.

The electric power supply server 100 outputs the synchronization packets A1, A2, A3, and the like when time slots that are specified intervals (for example, one-second intervals) start. Each of the time slots includes an information slot during which the information packets are transmitted and an electric power supply slot during which one of the electric power packets is transmitted. Information slots IS1, IS2, IS3, and the like are intervals during which the information packets are exchanged between the electric power supply server 100 and the clients CL1, CL2. Electric power supply slots PS1, PS2, PS3, and the like are intervals during which the electric power packets C1, C2, C3, and the like that are supplied from the electric power supply server 100 to the clients CL1, CL2 are output. The information packets are packets that can be output only in the intervals that are designated as information slots IS1, IS2, IS3, and the like. Therefore, in a case where the transmitting and the receiving of an information packet is not completed within a single information slot, the information packet is transmitted across a plurality of the information slots. For their part, the electric power packets are packets that can be output only in the intervals that are designated as electric power supply slots PS1, PS2, PS3, and the like.

The electric power supply server 100 has at least one server electric power profile that indicates the specifications of the electric power that it is capable of supplying, and the clients CL1, CL2 receive the electric power from the electric power supply server 100, which is capable of supplying electric power that conforms to the specifications of the clients CL1, CL2. When receiving the electric power, the clients CL1, CL2 acquire the server electric power profile from the electric power supply server 100 and determine the specifications (the server electric power profile) of the electric power supply server 100 with respect to the clients CL1, CL2. In order to do that, the clients CL1, CL2 first detect the synchronization packet Al that the electric power supply server 100 outputs and acquire an address for the electric power supply server 100 that is contained in the synchronization packet A1. The address can be a MAC address, for example. Next, each of the clients CL1, CL2 transmits the information packet D1, which requests the electric power supply server 100 to transmit the number of the server electric power profiles that it has.

Having received the information packet D1, the electric power supply server 100 transmits, in the information packet B1, the number of the server electric power profiles, which is the number of the server electric power profiles that the electric power supply server 100 has. Having received the information packet B1, each of the clients CL1, CL2 acquires from the electric power supply server 100 the server electric power profile contents for the number of the server electric power profiles that the electric power supply server 100 has. For example, in a case where the electric power supply server 100 has two server electric power profiles, each of the clients CL1, CL2 first acquires the first server electric power profile. Having acquired the first server electric power profile, each of the clients CL1, CL2 transmits the information packet D2 to the electric power supply server 100 to request use of the electric power supply.

Having received the two information packets D2, the electric power supply server 100 transmits to each of the clients CL1, CL2 the information packet B2, which is the first server electric power profile that is stored in a storage portion (not shown in the drawings) that is provided in the interior of the electric power supply server 100. Having received the information packet B2 from the electric power supply server 100, each of the clients CL1, CL2 transmits an information packet for acquiring the second server electric power profile. However, at this time, the information slot IS1 has ended, and the electric power supply slot PS1 for transmitting the electric power packet has started. Therefore, the information packets will be transmitted in the next information slot IS2. Meanwhile, in the electric power supply slot PS1, the electric power is not supplied, because the clients CL1, CL2 have not determined the specifications for the electric power they will receive from the electric power supply server 100.

The electric power supply slot PS 1 ends, and the synchronization packet A2 that indicates the start of the next time slot is output from the electric power supply server 100. Then each of the clients CL1, CL2, having received the information packet B2 from the electric power supply server 100, transmits the information packet D3, which is information for acquiring the second server electric power profile.

Having received the two information packets D3, the electric power supply server 100 transmits to each of the clients CL1, CL2 the information packet B3, which is the second server electric power profile that is stored in the storage portion (not shown in the drawings) that is provided in the interior of the electric power supply server 100. Having received the information packet B3 and acquired the second server electric power profile that the electric power supply server 100 has, each of the clients CL1, CL2 selects the server electric power profile for the appropriate electric power supply specifications. Each of the clients CL1, CL2 then transmits the information packet D4 to the electric power supply server 100 to set the selected server electric power profile.

Having received the two information packets D4, the electric power supply server 100, in order to notify each of the clients CL1, CL2 that the first server electric power profile has been set, transmits to each of the clients CL1, CL2, in the form of the information packet B4, information that expresses a reply to the effect that the electric power specifications have been set. Then, when the information slot IS2 ends and the electric power supply slot PS2 starts, the electric power supply server 100 outputs the electric power packet C1 to and supplies the electric power to each of the clients CL1, CL2. Note that by using information that expresses a request to set the transmission start time, the clients CL1, CL2 can specify to the electric power supply server 100 the time at which to start supplying the electric power, that is, the time at which to transmit the electric power packet.

The electric power supply processing by the electric power supply system 1 according to the embodiment of the present invention has been explained above.

### 1-3. Method for Recovering when Malfunction Occurs

Next, a method for recovering when a malfunction occurs in the electric power supply system 1 according to the embodiment of the present invention will be explained, but before that is explained, exactly what a system malfunction and a system crash are will be described first.

The devices and elements that are used in the system that is disclosed in the aforementioned Japanese Patent Application Publication No. JP-A-2008-123051 include an electric power supply server that serves as an electric power supply source, an electric power client that serves as a load, and a bus line over which the electric power and signals are actually transmitted. Therefore, the methods for handling failures and malfunctions and the methods for recovering vary according to the portion of the system where the failure or malfunction occurs, and in depending on the situation, an automatic recovery may not possible or only an incomplete recovery can be achieved.

First, a failure of the electric power supply bus line will be described.

Electric power supply bus line failures, whether accidental or intentional, are roughly divided into two types, a disconnection and a short circuit. In a case where the electric power supply bus line has been disconnected, the electric power cannot be supplied and information cannot be exchanged, so that case will not be discussed here. By contrast, in a case where a short circuit occurs in the electric power supply bus line, it may be one of a complete short circuit, where the impedance becomes less than the impedance of electric power supply bus line, and an incomplete short circuit, where the impedance becomes less than it is supposed to be.

With respect to the cause of a complete short circuit, both a case where the electric power supply server and the client are shorted out and a case where the electric power supply bus line is shorted out by a conductor for some reason are conceivable. The electric power supply servers and the clients that are designed to be connected to the electric power supply system 1 incorporate mechanisms that protect against internal short circuits. These mechanisms may include a known fuse, for example. Therefore, the most readily conceivable cause of a complete short circuit is a short circuit in the electric power supply bus line itself.

In a case where a short circuit has occurred in the electric power supply bus line itself, both a case where the electric power supply server and the client that are connected to the electric power supply bus line can detect the short circuit and a case where they cannot detect it can be assumed. In the case where the electric power supply server and the client cannot detect the short circuit, the entire electric power supply system will be in an inoperable state, so as long as the cause of the short circuit is not physically removed, the electric power supply system cannot recover completely. Therefore, instead of discussing the case where the electric power supply server and the client cannot detect the short circuit, the explanation will hereinafter focus on the case where the electric power supply server and the client can detect the short circuit. Note that even in the case where the electric power supply server and the client cannot detect the short circuit, it is possible for the electric power supply server and the client to determine that they are not connected to the electric power supply bus line and to turn off their own main switches.

A case in which a short circuit in the electric power supply bus line occurs at a high frequency instead of at a low frequency is handled in the same manner as a complete short circuit. This is because a short circuit in the electric power supply bus line that occurs at a high frequency makes it impossible to detect the packets, which in turn makes communication over the electric power supply bus line absolutely impossible, so the electric power supply server and the client that are connected to the electric power supply bus line treat the situation as equivalent to a case in which they have been disconnected from the electric power supply system.

In the explanation the follows, three cases will be explained, one in which a short circuit in the electric power supply bus occurs on the electric power supply bus line, one in which a short circuit occurs within the electric power supply server, and one in which a short circuit occurs within the client.

Next, a system crash will be defined. Devices that are provided with microprocessors are connected to an electric power supply system like that shown in FIG. 1. Therefore, when a system crash occurs, that is, when a failure or damage occurs in a microprocessor, the system may cease to function. The most likely cause of a crash is generally malfunctioning or damage in a microprocessor, which causes high noise and high voltage to be imposed on the electric power supply bus line. Countermeasures are therefore implemented against failure and damage in the microprocessor, the typical countermeasures including static electric shielding for the microprocessor itself and for the area around the microprocessor, the insertion of a diode for high voltage clamping in the processor“s signal line, the insertion of a surge arrestor initiate at least one of the signal line and the electric power supply bus line, and the like. In the present embodiment, only operations with respect to malfunctions and damage that occur in the microprocessor after these typical countermeasures have been implemented will be described.

Note that although the term system crash is used, in fact the greatest impact on the system is from a malfunction of a server that is connected to the electric power supply bus line, particularly a synchronization server that performs synchronization processing. If the synchronization server malfunctions or fails, it becomes impossible to sustain the electric power supply system (for as long as the failure lasts). A watchdog timer is used to monitor for a malfunction of the synchronization server, particularly for a malfunction of its microprocessor. If a malfunction of the microprocessor occurs, the synchronization server ceases to function as the synchronization server, and the electric power supply system reverts to its initial state, in which the synchronization between the electric power supply server and the client has not been established.

In contrast, in a case where the microprocessor is damaged, the problem that has the greatest direct impact is that the port that controls the main electric power supply switch is damaged in the direction where it connects to the main electric power supply switch. In a case where this sort of situation occurs and the functioning of the microprocessor is impaired, an electric current fuse that is provided as hardware cannot be expected to operate effectively. In the present embodiment, the occurrence of a situation in which the port that controls the main electric power supply switch is damaged in the direction where it connects to the main electric power supply switch will not be discussed, and a case will be explained in which system recovery is attempted by detecting the shift to the initial state of electric power supply system in conjunction with the stopping of the synchronization server.

The system malfunction and the system crash in the present embodiment have been defined above. Next, an example of dealing with an incomplete short circuit of the electric power supply bus in the electric power supply system 1 according to the embodiment of the present invention will be explained.

At the point when the electric power supply system 1 is configured, it is possible to measure the bus line impedance between a specific server and a specific client. That is, when the supply voltage between the specific server and the specific client has been negotiated, the negotiated supply voltage is supplied from the electric power supply server to the client. The nominal value of the voltage that the electric power supply server supplies is known as data on the client side, and the nominal voltage value serves as a negotiating condition during the negotiation. Therefore, the client that receives the electric power from the electric power supply server already knows the value of the voltage that is supplied, within a certain range of error. To say “the voltage value within a certain range of error” means that a discrepancy can arise between the nominal value and the actual voltage value. The electric power supply server can also transmit information on the output voltage that it has measured to the client.

For its part, the client can measure the voltage at the receiving terminal. Therefore, the bus line impedance R is calculated by the equation:

R=(Electric power supply server output voltage−Client received voltage)/Client current.

Note that the bus line impedance R can be accurately derived by defining the electric power supply server output voltage as the voltage value that the electric power supply server has actually measured, but if only a rough estimate is needed, the nominal voltage that the electric power supply server outputs may also be used.

The value of the bus line impedance R is stored in the client. Then the client monitors the bus line impedance R by measuring the actual voltage and the actual current every time it receives the electric power. The client's operation of monitoring the bus line impedance R is performed both to discover any malfunctions in the bus line and, in effect, to inspect the product that is delivered by measuring the actual voltage and the actual current. In other words, the client continuously monitors whether the promised amount of electric power (energy) is being transmitted properly from the electric power supply server. Of course, the value of the bus line impedance R may also be transmitted to the servers (the synchronization server that performs the synchronization processing and a non-synchronization server the actually performs the supplying of the electric power), and the voltage and the current may also be monitored by the servers. Realistically, it is preferable to increase redundancy with respect to the detection of malfunctions by having both the server and the client constantly monitor the bus line impedance R.

Assuming that the bus line is short circuited and that a low impedance is connected to the electric power supply system, the electric power supply server and the client detect the malfunction by measuring a voltage drop that is greater than it is supposed to be. Ordinarily, the effect of the voltage drop is to reduce a current I. At this time, the client immediately turns the main electric power supply switch of Then, in order to determine the cause of the abnormal voltage, the client transmits to the server a notification (an inspection failure notification) that includes the actually measured data. At the same time, the client performs self-diagnostic processing in order to determine whether the cause of the voltage drop is in the client itself. The method for performing the self-diagnosis in the client will be described in detail later.

In a case where the result of the self-diagnostic processing by the client makes clear that the cause of the voltage drop is in the client itself, the client transmits a client disconnect request to the synchronization server, and when a disconnect processing complete notification is received from the synchronization server, the client indicates that a failure has occurred (for example, by outputting a display or a sound that indicates that a failure has occurred) and stops all subsequent operation. On the other hand, in a case where the result of the self-diagnostic processing by the client is that the client itself has been determined to be normal, the client waits for the server to reply to the inspection failure notification.

At the same time, a voltage drop in the bus line can always be detected by constantly monitoring the voltage and the current on the server side. If a voltage drop in the bus line is detected on the server side, a flag (an alert flag) is set internally for the corresponding (negotiating) client, a self-diagnostic processing request is transmitted to the client, and the server performs its own self-diagnostic processing. At this time, the server also turns of the main switch for the corresponding client.

In a case where the result of the self-diagnostic processing by the server is that a malfunction is found on the server side, the server performs the operations described below.

(1) Case Where the Server is the Synchronization Server

The synchronization server performs management of the entire electric power supply system by outputting the synchronization packets for the system. Therefore, in a case where it has been determined that the synchronization server has the power to shut down the system, the synchronization server broadcasts a system stop command to the entire system and stops its own subsequent operations (as the synchronization server). Note that in addition to broadcasting the system stop command, the synchronization server may also stop outputting the synchronization packets. All of the servers and the clients in the system recognize that the electric power supply system is operating by constantly monitoring the synchronization packets that the synchronization server transmits, so if there are no synchronization packets from the synchronization server, the system is first reset to its initial state, then is restarted by the selection of the synchronization server. Whatever the case, the synchronization server that has discovered its own failure stops all subsequent operation.

(1) Case Where the Server is Not the Synchronization Server

If the result of the self-diagnostic processing is that a malfunction is detected in the server itself, and the server is not the synchronization server, but rather another server (for example, the electric power supply server), the server stops all subsequent operations as a server and outputs a system disconnect packet to the synchronization server. As soon as a reply to the system disconnect packet is received from the synchronization server, the server stops all server operations, outputs some sort of failure notification, and stops all subsequent operations (as a server). The failure notification may be, for example, the outputting of a display or a sound that indicates that a failure has occurred. At this time, the malfunctioning server is disconnected from the system for purposes of transmitting and receiving information (logically disconnected) and for purposes of transmitting the electric power, even though it is still physically connected to the system.

In a case where the results of the self-diagnostic processing are that it has been determined that failures have occurred on both the server side and the client side, a determination is made that some sort of failure has occurred in the bus line. A determination is also made that a failure has occurred in the bus line in a case where voltage abnormalities are simultaneously detected in a plurality of the clients. In this case, the synchronization server transmits the system disconnect packets to all of the servers and the clients in the electric power supply system, outputs a failure notification to the outside, and stops all subsequent operations as the synchronization server. The failure notification may be, for example, the outputting of a display or a sound that indicates that a failure has occurred. The system disconnect packets that are transmitted from the synchronization server also contain, as parameters, parameters that indicate all of the servers and the clients. In a case where a bus line failure such as this has occurred, the entire system stops, and the system does not resume operation until the cause of the failure that has occurred in the bus line is removed.

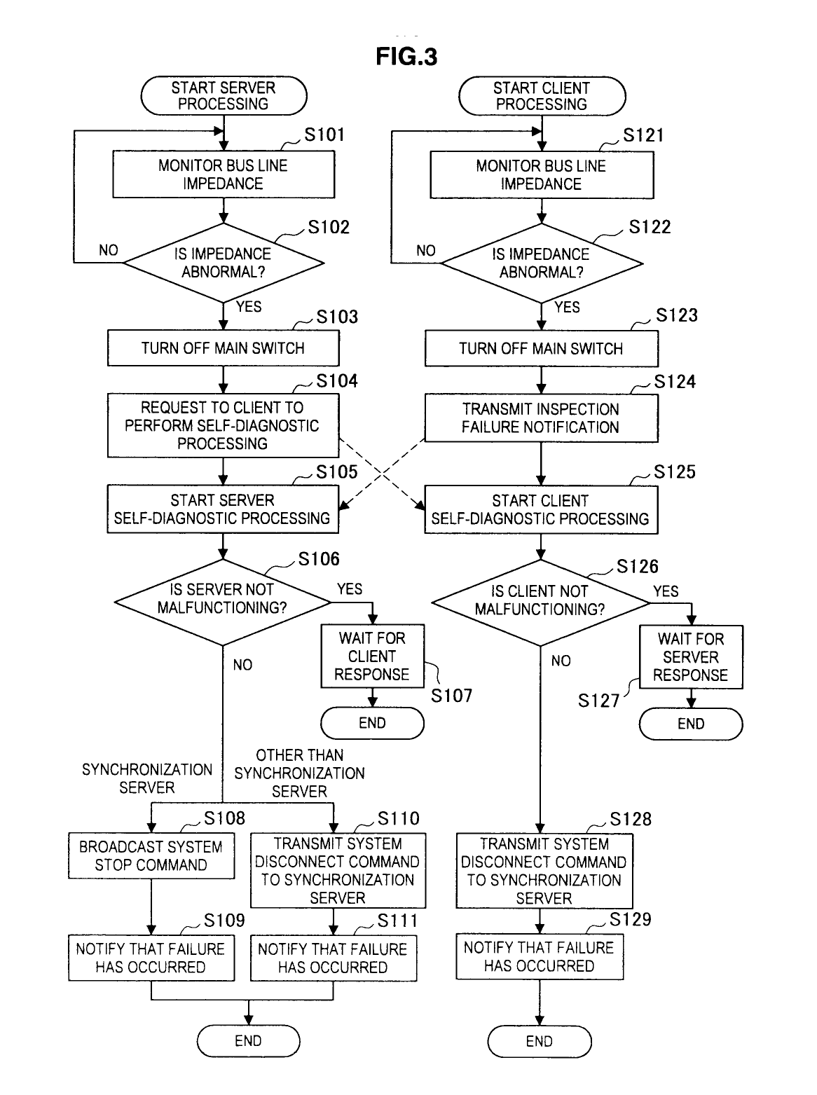

FIG. 3 is a flowchart that shows the self-diagnostic processing that is described above. The self-diagnostic processing on the server side (the synchronization server and the electric power supply server) will be explained first. The processing on the server side will be explained first. The server monitors the value of the bus line impedance R (Step S101) and determines whether or not the value of the bus line impedance R is an abnormal value (Step S102).

In a case where the result of the determination at Step S102 is that the value of the bus line impedance R is not an abnormal value, the processing returns to Step S101 and continues monitoring the value of the bus line impedance R. On the other hand, in a case where the result of the determination at Step S102 is that an abnormal value for the bus line impedance R is detected, the server turns off the main switch for the client (Step S103), transmits a request to the clients that are connected to the electric power supply system (that is, connected to the bus line) to perform the self-diagnostic processing (Step S104), and starts the self-diagnostic processing for itself (Step S105).

A determination is made as to whether or not the result of the server self-diagnostic processing is that there is no malfunction in the server (Step S106), and in a case where there is no malfunction in the server, the server waits for the result of the client's self-diagnostic processing (Step S107). On the other hand, in a case where the result of the server self-diagnostic processing is that there is a malfunction in the server, if the server is the synchronization server, it broadcasts the system stop command (Step S108) and provides notification that a failure has occurred in the server (Step S109). If the server is not the synchronization server, it transmits the system disconnect packet to the synchronization server (Step S110) and provides notification that a failure has occurred in the server (Step S111).

Next, the processing on the client side will be explained. The client monitors the value of the bus line impedance R (Step S121) and determines whether or not the value of the bus line impedance R is an abnormal value (Step S122).

In a case where the result of the determination at Step 5122 is that the value of the bus line impedance R is not an abnormal value, the processing returns to Step S121 and continues monitoring the value of the bus line impedance R. On the other hand, in a case where the result of the determination at Step S102 is that an abnormal value for the bus line impedance R is detected, the client turns off its own main switch (Step S123), transmits the inspection failure notification to the server (Step S124), and starts the self-diagnostic processing for itself (Step S125).

A determination is made as to whether or not the result of the client self-diagnostic processing is that there is no malfunction in the client (Step S126), and in a case where there is no malfunction in the client, the client waits for the result of the servers self-diagnostic processing (Step S127). On the other hand, in a case where the result of the client self-diagnostic processing is that there is a malfunction in the client, the client transmits the system disconnect packet to the synchronization server (Step S128) and provides notification that a failure has occurred in the client (Step S129).

### 1-4. Electric Power Supply Server Configuration Example

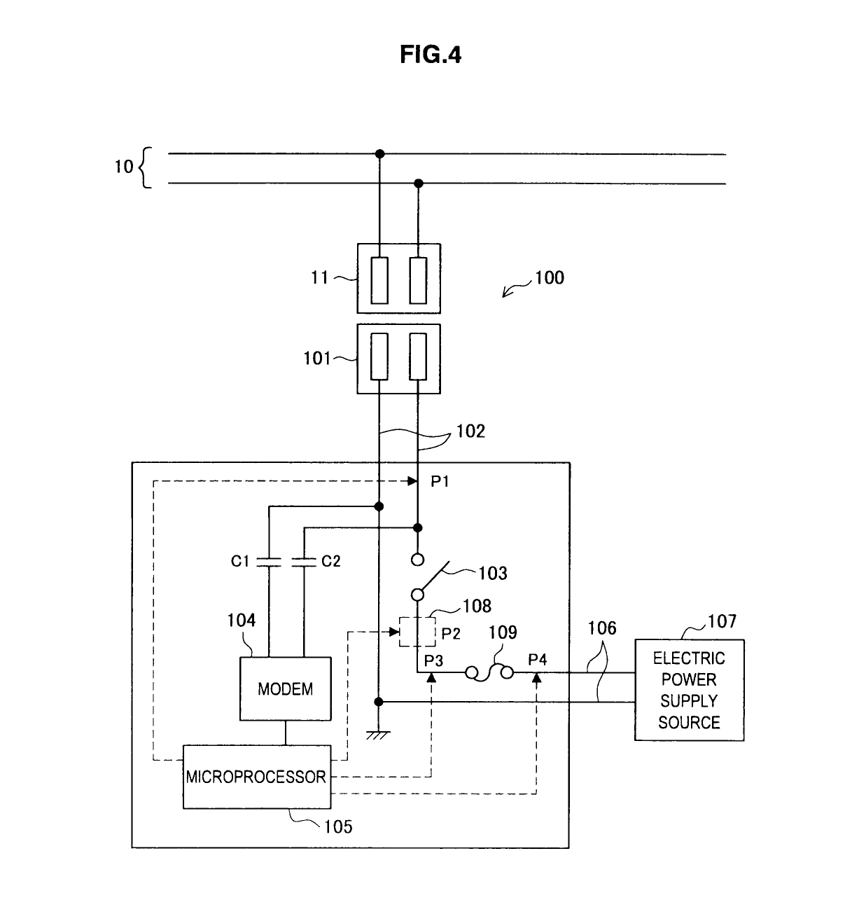

Next, an example of the configuration of the electric power supply server 100 according to the embodiment of the present invention, which is capable of performing the self-diagnostic processing that is described above, will be explained. FIG. 4 is an explanatory figure that shows the configuration of the electric power supply server 100 according to the embodiment of the present invention. Hereinafter, the configuration of the electric power supply server 100 according to the embodiment of the present invention will be explained using FIG. 4.

As shown in FIG. 4, the electric power supply server 100 according to the embodiment of the present invention is configured such that it includes a connector 101, connecting lines 102, 106, a main switch 103, a modem 104, a microprocessor 105, an electric power supply source 107, an electric current sensor 108, a fuse 109, and capacitors C1, C2.

The connector 101 connects the main body of the electric power supply server 100 to the bus line 10 by connecting to a connector 11 of the bus line 10. The connecting lines 102 connect the connector 101 to the main body of the electric power supply server 100. The main switch 103 controls the output of the electric power, and if the main switch 103 is on, the electric power supply server 100 supplies the electric power from the electric power supply source 107 to the bus line 10. On the other hand, if the main switch 103 is off, the electric power supply server 100 can stop the supplying of the electric power from the electric power supply source 107.

The modem 104 performs transmission and receiving of information to and from other electric power supply servers and clients that are connected to the bus line 10. A high-frequency communication signal is transmitted from the modem 104 to the bus line 10, and the high-frequency communication signal that reaches the bus line 10 is received. Note that the capacitors C1, C2 are provided between the bus line 10 and the modem 104, and they prevent the direct current that flows through the bus line 10 from flowing to the modem 104.

The microprocessor 105 controls the operation of the electric power supply server 100 and monitors the voltage and the electric current in the interior of the electric power supply server 100. When the negotiation between the electric power supply server 100 and the client (for example, one of the clients 200 in FIG. 1) is completed, the microprocessor 105 turns the main switch 103 on in order to supply the electric power from the electric power supply source 107. Furthermore, monitoring the voltage and the electric current in the interior of the electric power supply server 100 makes it possible for the microprocessor 105 to detect the occurrence of a malfunction in the electric power supply system 1 and to issue a command to another device that is connected to the bus line 10 to start the self-diagnostic processing.

The connecting lines 106 connect the electric power supply source 107 to the main body of the electric power supply server 100. The electric power supply source 107 can supply the electric power in the form of a direct current voltage, and when the main switch 103 of the electric power supply server 100 is turned on, the electric power supply source 107 can supply the direct current electric power to the bus line 10.

The electric current sensor 108 detects the volume of the electric current that flows between the main switch 103 and the electric power supply source 107. Using the electric current sensor 108 to detect the volume of the electric current that flows between the main switch 103 and the electric power supply source 107 makes it possible for the microprocessor 105 to determine whether or not the electric power is being output properly from the electric power supply source 107 and whether the electric current that is flowing through the bus line 10 is normal. The fuse 109 protects the circuitry from excessive electric current and prevents excessive electric current from flowing by using heat that it generates itself to disconnect if an electric current flows that exceeds the rating of the fuse 109.

The configuration of the electric power supply server 100 according to the embodiment of the present invention has been explained above using FIG. 4. Next, the self-diagnostic processing in the electric power supply server 100 that has the configuration shown in FIG. 4 will be explained.

The microprocessor 105 can measure data for the self-diagnostic processing in the electric power supply server 100 at points P1 to P4 that are shown in FIG. 4.

P1: Bus line output terminal voltage

P2: Bus line electric current

P3: Bus line main switch terminal voltage

P4: Bus line electric power supply terminal voltage

When the self-diagnostic processing is performed by the microprocessor 105, the meanings of the voltages and the electric currents at these measurement points are as described below.

P1: The actually measured voltage that is output to the bus line 10. If this value is within a specified range in relation to the negotiated voltage, it means that the electric power from the electric power supply server 100 is being output normally. In a case where the value is outside the specified range, the microprocessor 105 determines that a problem has occurred somewhere in the electric power supply system 1.

P2: The electric current that flows through the bus line 10. The electric current that is output from the electric power supply server 100 to the bus line 10 is detected at P2, and if the electric current value is within a specified range in relation to the negotiated electric current value, it means that the electric current is being output normally. In a case where the value is outside the specified range, the microprocessor 105 determines that a problem has occurred somewhere in the electric power supply system 1.

P3: This is the voltage on the electric power supply source 107 side of the main switch 103, and the state of the main switch 103 can be checked using the value at P3. In a case where there is a voltage only at P3, and no voltage output is seen at P1, even if the main switch 103 has been turned on, as well as in a case where the voltage at P3 is not greater than a prescribed value, the microprocessor 105 can determine that some sort of failure has occurred in the main switch 103.

P4: This is the actual output voltage from the electric power supply server 100, and a disconnect by the fuse 109, for example, can be detected by comparing the value at P4 to the voltage value that is detected at one of P1 and P3. A determination can also be made as to whether the electric power supply source 107 itself is not outputting the prescribed output (due to some sort of failure, for example).

Detecting the voltages and the electric current in the interior of the electric power supply server 100 in this manner makes it possible for the electric power supply server 100 to perform the self-diagnostic processing for the electric power supply system in a single pass.

In contrast, self-diagnostic processing by the microprocessor 105 and the modem 104 is performed as hereinafter described. First, for the microprocessor 105, it is possible to detect whether a program has hung up by using a watchdog timer, and even if a program does hang up, a reset start operation can be performed.

The main switch 103 is under the control of the microprocessor 105, so it is desirable for the main switch 103 to be structured such that it turns off if signals cease to come from the microprocessor 105. For example, the main switch 103 may be structured such that it is on at a logic level 1 and turns off when the microprocessor 105 ceases to operate due to its internal power supply being turned off. Of course, a failure can occur in which the port through which the microprocessor 105 controls the main switch 103 remains on, but in that case, the probability is high that the microprocessor 105 power supply is normal, so the time at which the power supply output is turned off can be detected with high probability by monitoring P1 and P2. (The electric power is output on a time-sharing basis, but a guard time that is inserted into the output time slot can be detected.) However, in a state in which the microprocessor 105 has failed and the main switch 103 has been left on, it is difficult for the electric power supply server 100 itself to handle the problem, so the system is reset.

Furthermore, in a case where, as occasionally happens, another electric power supply server fails and the voltage value is the same as for the electric power supply server 100, within a specified range, it cannot be determined that the other electric power supply server has failed, but in a case where the voltage is also detected within the guard time, the synchronization server resets the system. The electric power supply server 100 then selects the synchronization server and performs processing to add the other server, but in a case where the voltage appears on the bus line during this process, the system is reset, and the electric power supply server 100 no longer operates as the electric power supply server.

Ultimately, a failure in which the main switch 103 of the electric power supply server 100 remains on is handled differently depending on whether the self-diagnostic processing for the failed server is performed first or the synchronization server resets the system first, but in both cases, the failed server is disconnected from the electric power supply system 1 as long as the internal microprocessor 105 is operating.

The diagnosis of the modem 104 does not diagnose an operation failure in the modem 104 itself, but when communication is completely cut off, a determination is made that the connector 101 has been disconnected (that is, disconnected from the electric power supply system 1). With regard to a communication error, the modem 104 monitors whether or not the electric power supply server 100 is connected to the electric power supply system 1 by counting the number of times that the synchronization packet is not received, so the modem 104 can keep at least one of the user and a manager informed as to the state of connection or disconnection by providing notification in the form of an LED (not shown in the drawings), a warning sound, or the like, for example. In other words, in a case where the notification is provided, it is possible to determine that a failure has occurred in the interior of the electric power supply server 100, even though the electric power supply server 100 is physically connected to the electric power supply system 1.

The self-diagnostic processing in the electric power supply server 100 that has the configuration shown in FIG. 4 has been explained above. Next, an example of the configuration of the client according to the embodiment of the present invention, which is capable of performing the self-diagnostic processing that is described above, will be explained.

### 1-5. Client Configuration Example

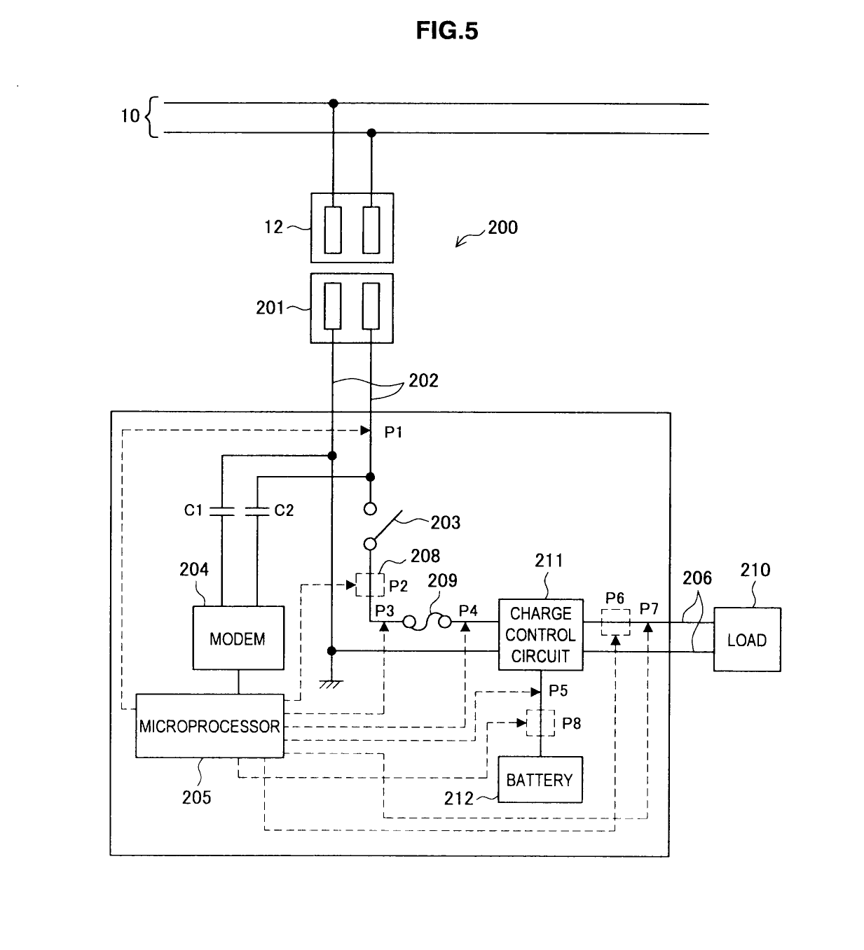

FIG. 5 is an explanatory figure that shows an example of the configuration of the client 200 according to the embodiment of the present invention. Hereinafter, the configuration of the client 200 according to the embodiment of the present invention will be explained using FIG. 5.

The client 200 according to the embodiment of the present invention is configured such that it includes a connector 201, connecting lines 202, 206, a main switch 203, a modem 204, a microprocessor 205, an electric current sensor 208, a fuse 209, a load 210, a charge control circuit 211, a battery 212, and capacitors C1, C2.

The connector 201 connects the main body of the client 200 to the bus line 10 by connecting to a connector 12 of the bus line 10. The connecting lines 202 connect the connector 201 to the main body of the client 200. The main switch 203 controls the input of the electric power, and if the main switch 203 is on, the client 200 can receive the electric power that is supplied from the electric power supply server 100 through the bus line 10. On the other hand, if the main switch 203 is off, the client 200 cannot receive the electric power that is supplied from the electric power supply server 100.

The modem 204 performs transmission and receiving of information to and from other electric power supply servers and clients that are connected to the bus line 10. A high-frequency communication signal is transmitted from the modem 204 to the bus line 10, and the high-frequency communication signal that reaches the bus line 10 is received. Note that the capacitors C1, C2 are provided between the bus line 10 and the modem 204.

The microprocessor 205 controls the operation of the client 200 and monitors the voltage and the electric current in the interior of the client 200. When the negotiation between one of the electric power supply servers (for example, the electric power supply server 100 in FIG. 1) and the client 200 is completed, the microprocessor 205 turns the main switch 203 on in order to receive the electric power from the electric power supply server. Monitoring the voltage and the electric current in the interior of the client 200 also makes it possible for the microprocessor 205 to detect the occurrence of a malfunction in the electric power supply system 1.

The connecting lines 206 connect the load 210 to the main body of the client 200. The electric current sensor 208 detects the volume of the electric current that flows between the main switch 203 and the load 210. Using the electric current sensor 208 to detect the volume of the electric current that flows between the main switch 203 and the load 210 makes it possible for the microprocessor 205 to determine whether the electric current that is flowing through the bus line 10 is normal. The fuse 209 protects the circuitry from excessive electric current and prevents excessive electric current from flowing by using heat that it generates itself to disconnect if an electric current flows that exceeds the rating of the fuse 209.

The load 210 consumes the electric power that is supplied from the electric power supply server. The charge control circuit 211 is a circuit that controls the charging and the discharging of the battery 212. The battery 212, under the control of the charge control circuit 211, accumulates the electric power that is supplied from the electric power supply server and discharges to the load 210 and the like the electric power that it has accumulated under the control of the charge control circuit 211.

The configuration of the client 200 according to the embodiment of the present invention has been explained above using FIG. 5. Next, the self-diagnostic processing in the client 200 that has the configuration shown in FIG. 5 will be explained.

The microprocessor 205 can measure data for the self-diagnostic processing in the client 200 at points P1 to P8 that are shown in FIG. 5.

P1: Bus line output terminal voltage

P2: Bus line electric current

P3: Bus line main switch terminal voltage

P4: Bus line electric power supply terminal voltage

P5: Battery terminal voltage

P6: Final load electric current

P7: Final load voltage

P8: Battery charging current and discharging current

The operations that can be detected at the points P1 to P4 are the same as those at the points P1 to P4 in the electric power supply server 100, so explanations will be omitted, and only the points P5 to P8 that are particular to the client 200 will hereinafter be explained.

P5, P8: These points are used for the charge control of the battery 212. Note that there can be cases in which all of the charge control for the battery 212 is performed by the charge control circuit 211, but here a case will be described in which the microprocessor 205 also performs the charge control for the battery 212. By definition, the values that are detected at P5 and P8 can also be used for detecting a failure of the battery 212. A method that is already used in laptop personal computers and the like may also be used to diagnose a failure of the battery 212. Note that the battery 212 is almost never a single cell, so it is desirable for the measurement point P5 to actually be a plurality of measurement points whose number is the same as the number of the battery cells.

P6, P7: These measurement points are points for detecting the values of the voltage and the electric current that are actually supplied to the load 210, and in a case where these values are being monitored and a value is detected that is different from a value for the load 210 that has been set in advance, a determination is made that a failure has occurred at the load terminal. In that case, the client 200 stops operating and is disconnected from the electric power supply server. In some cases the fuse 209 disconnect first, and the client 200 is disconnected from the electric power supply system 1 in the end.

The self-diagnostic processing in the client 200 that has the configuration shown in FIG. 5 has been explained above. In the preceding explanations, the emergency countermeasures and system reset processing in the electric power supply server and the client were described. Basically, each of the servers and the clients has its own independent self-diagnostic function, and the system is designed to be highly robust by making the basic operation one of disconnecting the failed device from the electric power supply system 1 without allowing the failure in the one device to spread to the electric power supply system 1.

### 1-6. Monitoring Device Configuration Example

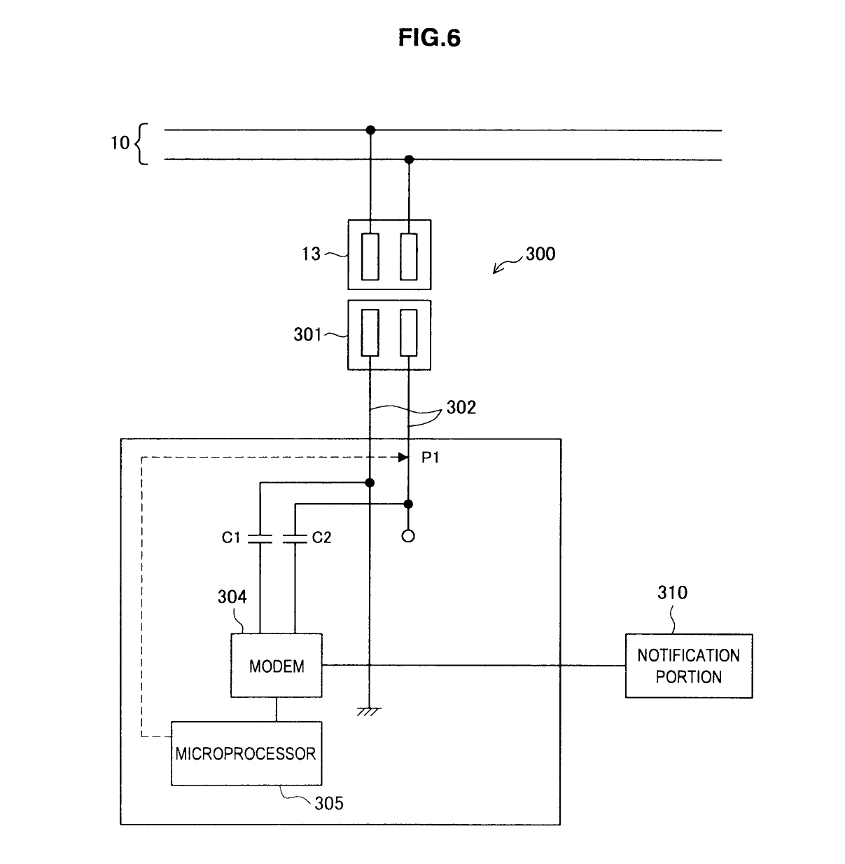

Next, the configuration of a monitoring device that is connected to the electric power supply system 1 and has a function that is different from those of the server and the client (specifically, not an electric power supply source and not a final load) will be described. FIG. 6 is an explanatory figure that shows the configuration of a monitoring device 300 that is connected to the electric power supply system 1 according to the embodiment of the present invention. Hereinafter, the configuration of the monitoring device 300 that is connected to the electric power supply system 1 according to the embodiment of the present invention will be explained using FIG. 6.

As shown in FIG. 6, the monitoring device 300 according to the embodiment of the present invention is configured such that it includes a connector 301, connecting lines 302, a modem 304, a microprocessor 305, a notification portion 310, and capacitors C1, C2.

The connector 301 connects the main body of the monitoring device 300 to the bus line 10 by connecting to a connector 13 of the bus line 10. The connecting lines 302 connect the connector 301 to the main body of the monitoring device 300. The modem 304 performs transmission and receiving of information to and from other electric power supply servers and clients that are connected to the bus line 10. A high-frequency communication signal is transmitted from the modem 304 to the bus line 10, and the high-frequency communication signal that reaches the bus line 10 is received. Note that the capacitors C1, C2 are provided between the bus line 10 and the modem 304, and they prevent the direct current that flows through the bus line 10 from flowing to the modem 304.

The microprocessor 305 controls the operation of the monitoring device 300 and monitors the voltage and the electric current in the interior of the monitoring device 300. When the negotiation between one of the electric power supply servers (for example, the electric power supply server 100 in FIG. 1) and the client 200 is completed, the packets move through the bus line 10, and the microprocessor 305 monitors the packets that move through the bus line 10. Furthermore, monitoring the voltage and the electric current in the interior of the monitoring device 300 makes it possible for the microprocessor 305 to detect the occurrence of a malfunction in the electric power supply system 1.

As described above, the microprocessor 305 monitors the signals (the packets) that move through the bus line 10. In a case where the monitoring device 300 is connected to the electric power supply system 1 for which the negotiation between the electric power supply servers and the clients has been completed, the monitoring device 300 queries the synchronization server and acquires basic data (that is, basic data on the configuration of the current electric power supply system 1), then performs the monitoring using the acquired basic data. In particular, monitoring the packets makes it possible for the monitoring device 300 to determine when servers and clients are added to and disconnected from the system, but even if it detects the packets that are related to the adding and the disconnecting, it is preferable for the monitoring device 300 not to make the determination on its own. Instead, the monitoring device 300 waits until a transaction is completed, then queries the synchronization server and updates the data. The monitoring device 300 may also be structured such that it updates the data the regular intervals.

The microprocessor 305 is provided with a protocol that is used by the electric power supply system 1, and it has a portion that interprets and executes all transactions and a portion that acquires from the synchronization server (not shown in the drawings) information that the synchronization server has. The microprocessor 305 also has at least a portion that issues disconnection request packets to all of the devices in the electric power supply system 1. Note that the disconnection request packets are included in the aforementioned “all transactions”, but they are noted here for emphasis.

The microprocessor 305 also has a portion that monitors the voltage value of the bus line 10. Note that it is acceptable both to monitor the electric current value and not to monitor it. The monitoring device 300 can also determine when a failure occurs in the monitoring device 300 itself by monitoring the electric current that it consumes, but the detecting of a failure occurrence in the monitoring device 300 itself will not be discussed here.

The notification portion 310 is a portion for making a human being aware of the operating states of the electric power supply system 1 and the various devices that are connected to the electric power supply system 1. The notification portion 310 can provide notification using at least one of an LED for a visual notification and a sound for an audible notification, and it can also be connected to a wireless LAN and provide notification through the wireless LAN. Explanations of notification procedures by portions other than the notification portion 310 and communication procedures by portions other than bus line 10 will be omitted here.

Note that the monitoring device 300 may also be provided with a battery for its own operation, although this is not shown in FIG. 6. Providing a battery makes it possible for the monitoring device 300 even if there is no supply of electric power from an electric power supply server.

The configuration of the monitoring device 300 according to the embodiment of the present invention has been explained above. In order to determine whether or not the voltage of the bus line 10 corresponds to the state that was negotiated between the server and the client, the monitoring device 300 monitors the packets on the bus line 10. That is, the monitoring device 300 monitors the negotiation between the server and the client and determines whether or not the current voltage matches the result of the negotiation. The monitoring device 300 can therefore detect a failure that occurs in the electric power supply system 1, such as a (incomplete) short circuit of the bus line 10. This makes it possible for the monitoring device 300 to transmit and/or broadcast the system disconnect request to the one of the server and the client where the failure has occurred.

It might be expected that this sort of operation by the monitoring device 300 would basically be performed by the server and the client that have the configurations that have been described above, but the server and the client get their electric power by being connected to the bus line 10, so there is a strong possibility that the server and the client themselves will be damaged when a failure occurs. The monitoring device 300 has an electric power supply for its own use (a compact battery, for example) and is connected to the bus line 10 only at the signal level, so even in a case where a system failure occurs, there is a strong possibility that the monitoring device 300 will continue to be operative. There is therefore a strong possibility that the monitoring device 300 will reliably perform an emergency stop (for example, processing to transmit the system disconnect request) with respect to the other devices, such as the servers and the clients, thereby enhancing the robustness of the system.

Conversely, the monitoring device 300 keeps to a minimum its requests to the devices that are connected to the electric power supply system 1, and it operates only in cases where an emergency situation has developed. For example, the monitoring device 300 can also use a method whereby it monitors the synchronization packets that move through the bus line 10 and transmits processing to the various devices only after the synchronization packets are no longer present. However, it is preferable for the processing after the synchronization packets are no longer present to be left to the various devices that are connected to the electric power supply system 1, and for the monitoring device 300 to interfere with the system as little as possible.

On the other hand, the monitoring device 300 can use the notification portion 310, which includes an external display portion and a communication portion, to provide notification of the current state of the system, as well as to specify a device that has a history of malfunctioning or whose current operation is unstable and to transmit that information to the system manager. The system manager can then look at the information from the notification portion 310 and specify the location of a system failure and predict a system failure.

To take one example, providing notification in the form of a graph of the historical impedance between a specific server and a specific client that are connected to the electric power supply system 1 would make it possible to predict to what extent the impedance will be stable and whether instability will increase. Of course, if the system itself recognized the impedance history and recognized an increase in the impedance, an automatic operation could be performed to strengthen the electric current restriction, but the monitoring device 300 could also be used to express the impedance history in the form of a temporal series.

According to the embodiment of the present invention that has been explained above, the servers and the clients that are connected to the electric power supply system 1 are capable of performing self-diagnostic processing, and the self-diagnostic processing makes it possible to discover, among the devices that are connected to the electric power supply system 1, those devices in which at least one of a short circuit and a crash has occurred. Furthermore, providing notification of the operating state of the electric power supply system 1 in at least one of visible form and audible form makes it possible for the occurrence of a failure in the electric power supply system 1 to be detected quickly and for a failure to be predicted.

The preferred embodiment of the present invention has been explained in detail above with reference to the attached drawings, but the present invention is not limited to this example. It should be understood by those possessing ordinary knowledge of the technical field of the present invention that various types of modified examples and revised examples are clearly conceivable within the scope of the technical concepts that are described in the appended claims, and that these modified examples and revised examples are obviously within the technical scope of the present invention.

The present invention can be applied to an electric power supply device, an electric power receiving device, an electric power supply system, and a failure recovery method, and can be applied in particular to an electric power supply device, an electric power receiving device, an electric power supply system, and a failure recovery method that supply electric power by superimposing information on the electric power.

The present application contains subject matter related to that disclosed in Japanese Priority Patent Application JP 2009-255233 filed in the Japan Patent Office on Nov. 6, 2009, the entire content of which is hereby incorporated by reference.

What is claimed is:

1. An electric power supply device, comprising:
an electric power supply portion that supplies, to another device with which an agreement has been established to supply electric power, the electric power that the agreement specifies, by supplying the electric power to a bus line during predetermined electric power supply intervals that recur cyclically;
an information communication portion that wirelessly transmits and receives, to and from the other device to which the electric power supply portion supplies the electric power, information signals that express information;
a control portion that controls the electric power that the electric power supply portion supplies and the information signals that the information communication portion transmits; and
an impedance measurement portion that measures the impedance of the bus line on a specified cycle.

2. The electric power supply device according to claim 1,
the control portion issues a command to start self-diagnostic processing to the other device that is receiving the electric power supply from the electric power supply portion, in a case where the impedance of the bus line that is measured by the impedance measurement portion is outside a predetermined range of normal values.

3. The electric power supply device according to claim 1,
the control portion issues a command to itself to start self-diagnostic processing, in a case where the impedance of the bus line that is measured by the impedance measurement portion is outside a predetermined range of normal values.

4. The electric power supply device according to claim 3,
the control portion stops the electric power supply from the electric power supply portion in a case where the self-diagnostic processing determines that a malfunction has occurred in the control portion.

5. An electric power receiving device, comprising:
an electric power receiving portion that receives, from another device with which an agreement has been established to supply electric power, the electric power that the agreement specifies, from a bus line during predetermined electric power supply intervals that recur cyclically;
an information communication portion that wirelessly transmits and receives, to and from the other device from which the electric power receiving portion receives the electric power, information signals that express information;
a control portion that controls the information signals that the information communication portion transmits; and
an impedance measurement portion that measures the impedance of the bus line on a specified cycle.

6. The electric power receiving device according to claim 5,
the control portion issues a command to the information communication portion to transmit a notification to the effect that the impedance is abnormal to the other device that is supplying the electric power, in a case where the impedance of the bus line that is measured by the impedance measurement portion is outside a predetermined range of normal values.

7. The electric power receiving device according to claim 5,
the control portion issues a command to itself to start self-diagnostic processing, in a case where the impedance of the bus line that is measured by the impedance measurement portion is outside a predetermined range of normal values.

8. The electric power receiving device according to claim 7,
the control portion issues a command to the information communication portion to transmit a notification to the effect that the receiving of the electric power will stop, in a case where the self-diagnostic processing determines that a malfunction has occurred in the control portion.

9. An electric power supply system, comprising:
an electric power supply server that outputs electric power to a bus line at a specified timing; and
a client that receives, through the bus line, the electric power that the electric power supply server outputs,
wherein
the electric power supply server includes
an electric power supply portion that supplies, to another device with which an agreement has been established to supply electric power, the electric power that the agreement specifies, during predetermined electric power supply intervals that recur cyclically,
an information communication portion that wirelessly transmits and receives, to and from the other device to which the electric power supply portion supplies the electric power, information signals that express information,
a control portion that controls the electric power that the electric power supply portion supplies and the information signals that the information communication portion transmits, and
an impedance measurement portion that measures the impedance of the bus line on a specified cycle,
and
the client includes
an electric power receiving portion that receives, from another device with which an agreement has been established to supply electric power, the electric power that the agreement specifies, during predetermined electric power supply intervals that recur cyclically,
an information communication portion that wirelessly transmits and receives, to and from the other device from which the electric power receiving portion receives the electric power, information signals that express information,
a control portion that controls the information signals that the information communication portion transmits, and
an impedance measurement portion that measures the impedance of the bus line on a specified cycle.

10. A failure recovery method, comprising the steps of:
supplying, to another device with which an agreement has been established to supply electric power, the electric power that the agreement specifies, by supplying the electric power to a bus line during predetermined electric power supply intervals that recur cyclically;
transmitting and receiving wirelessly, to and from the other device to which the electric power is supplied, information signals that express information;
controlling the electric power that is supplied and the information signals that are transmitted; and
measuring the impedance of the bus line on a specified cycle.
